(19) United States
(12) Patent Application Publication
(10) Pub. No.: US 2003/0074877 A1
(43) Pub. Date: Apr. 24, 2003

(54) Blade mounting apparatus for a cutting implement

(76) Inventors: Tivis Van Manuel, Jefferson City, TN (US); Bradley Robert Igl, Beaver Dam, WI (US); Gary David Hohnl, Slinger, WI (US)

Correspondence Address: Deere & Company, One John Deere Place, Moline, IL, 61265-8098, US

(21) Appl. No.: 09/982,334

(22) Filed: Oct. 18, 2001

(51) Int. Cl. A01D 34/52

(52) U.S. Cl. 56/295

(57) ABSTRACT

An apparatus for mounting a blade to a cutting implement is provided. The apparatus includes an adapter which enables the blade to be fastened with the implement with structure that is offset from its axis of rotation. With this mounting capability, structure used to secure the blade relative to the cutting implement experiences decreases occurrences of tightening relative to the blade with which it is associated. Accordingly, there is presented an enhanced ability to remove the blade when such removal is desired.

### FIELD OF THE INVENTION

This invention relates to devices used in the mounting of a cutting blade to a cutting implement, and more specifically, to structure used in reducing unwanted movement of the blade and the effect of destructive forces exerted on the blade and its mounting apparatus as a result of the blade operation and impacts from objects during that operation.

### BACKGROUND OF THE INVENTION

Often, the blade or blades of a cutting implement are mounted through the use of a bolt or nut arrangement. The bolt is ordinarily passed through an opening in the center of the blade and is centered across the width of the spindle housing so as to be inline with the spindle shaft. Interposed between the bolt head and the blade, a washer has been provided which, along with the bolt, creates a clamping force to hold the blade to the spindle shaft as it and thus, the blade, are turned. Each of these is rotated upon activation of a power transfer system, such as a series of belts and pulleys, which transmits power from a mower or tractor engine to spin the blade and cause it to move about its axis of rotation which extends through the spindle shaft and the middle of the blade itself.

Mounting the blade in the above manner whereby its surface is abutted against the spindle housing on one side and secured thereto by a spindle bolt or nut on its opposite side results in the creation of a friction joint between the blade and the spindle bolt or nut. This friction force is created by the surface contact existing between the blade and the tightened bolt and/or nut securing the blade to the surface of the spindle shaft. This joint often becomes disturbed or shifted whereby the bolt or nut is tightened to a point where it is difficult to remove and allow for the disassembly of the blade from the shaft.

Tightening of the above joint has often occurred in two instances. First, as the power transfer system is started and power is transmitted to the blade to allow it to rotate, the bolt and washer spin together and naturally tighten as a result of the spinning of the blade. This occurrence can be referred to as a self-tightening of this mounting structure against the blade and surface of the spindle shaft. Second, the bolt may be tightened against the washer and blade as a result of objects contacting or impacting the blade. Accordingly, portions of the blade become repositioned relative to the bolt and washer which places unintended pressure on the joint causing the bolt to become further tightened against the blade. Thus, tightening of the blade joint may occur in two situations which have caused the bolt or nut secured against the blade to become difficult to remove when maintenance on the blade is attempted.

Thus, it would be beneficial to provide a mounting assembly or arrangement which reduces the likelihood that structure used to secure the blade relative to the spindle housing will not tighten upon operation of the blade, including those instances in which the blade is impacted.

### SUMMARY OF THE INVENTION

Accordingly, there is provided an assembly that reduces the occurrences of tightening of the structure used to fasten the blade relative to the spindle housing and thus, the cutting implement, as the blade is operated.

The assembly consists of an adapter which is mounted so as to contact the spindle housing on a first surface thereof and the blade on its opposite surface. The spindle is passed through the adapter and matingly engages it. On opposite ends or sides of the adapter, apertures are provided to retain bolts used to secure the blade against the adapter and thus, the spindle housing.

To minimize tightening of the bolts and/or the adapter against the blade, the above assembly mounts the blade at two locations which are offset from the axis of rotation of the blade and the spindle with which it is associated. In doing so, the friction force existing between the mounting structure, the blade and the surface of the spindle shaft substantially at the axis of rotation, as in past designs, is greatly reduced. Accordingly, tightening of that mounting structure to the blade and spindle shaft as a result of the blade spinning is likewise diminished. Accordingly, removal of the blade is made easier.

Power is transferred to the blade through use of the adapter. To do so, the adapter is constructed to include a hexagonal feature which accepts a similarly constructed head or extension on the end of the spindle.

Thus, there is provided an assembly which reduces instances in which structure used to fasten the cutting blade relative to the spindle housing tightens upon operation of the blade.

### BRIEF DESCRIPTION OF THE DRAWINGS

FIG. 1 is a front and side elevated perspective view of a cutting implement including the blade mounting apparatus of the present invention.

FIG. 2 is a front perspective view of the underside of the cutting implement showing the blade mounting apparatus.

FIG. 3 is a front perspective view showing the blade mounting apparatus detached from the cutting implement and the blade which is to be secured thereto.

FIG. 4 is an enlarged view of the blade mounting apparatus of the present invention.

FIG. 5 is a sectional view according to lines 5--5 as shown in FIG. 1.

FIG. 6 is front and elevated view of a cutting implement having a blade mounting apparatus of the prior art.

### DESCRIPTION OF THE PREFERRED EMBODIMENT

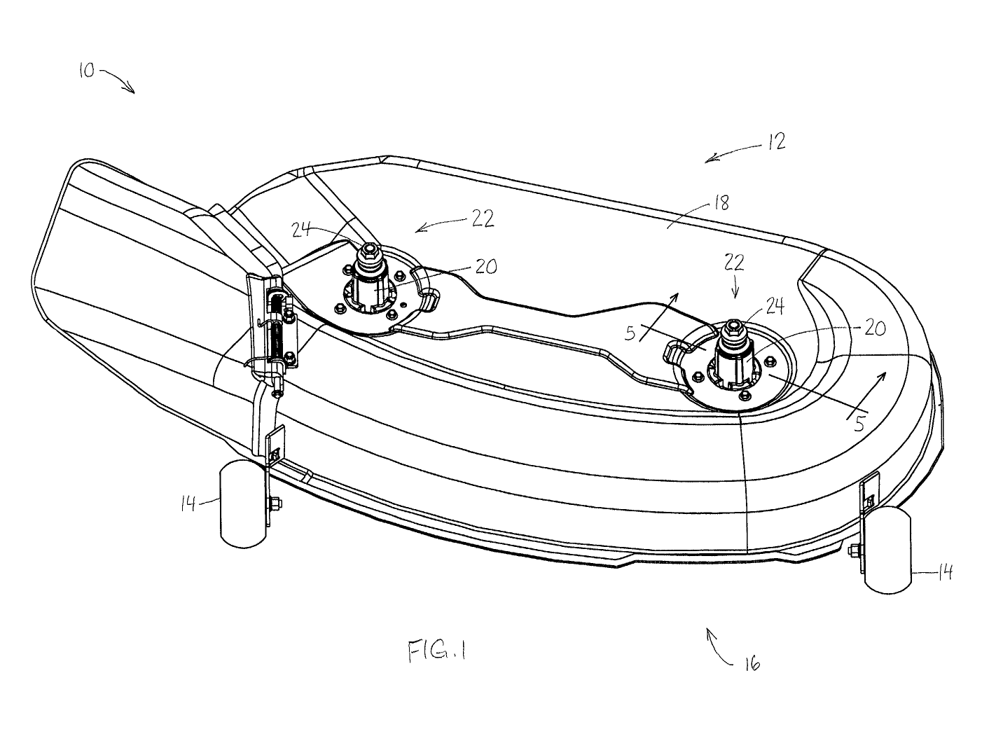

Looking to FIG. 1,there is shown a cutting implement 10 usable with a lawn and garden tractor (not shown). The implement 10 is ordinarily suspended from the tractor by suitable connections therewith (not shown) at its rear 12 and includes several anti-scalp wheels 14 at its front 16. On a top surface 18 of the implement 10, there is shown the top portion 20 of a blade spindle housing 22. At the end of the top portion 20, a nut 24 is provided which matingly engages the spindle to which the blade is attached, as discussed below.

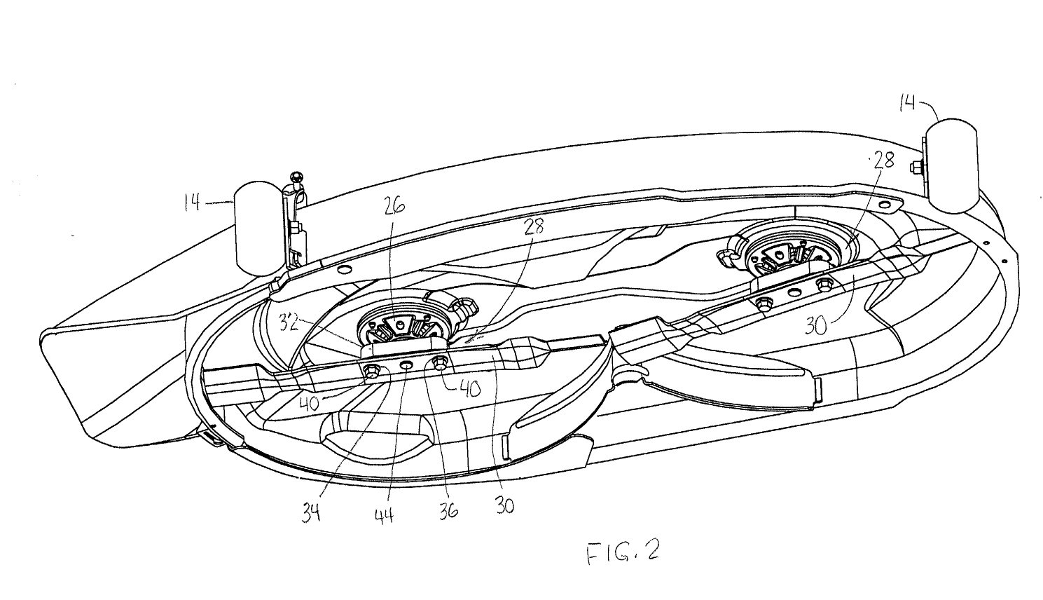

Focusing now on FIG. 2, the underside of the implement is shown. As can be seen, the bottom portion 26 of the spindle housing 22 is shown and against which is abutted an assembly 28 for mounting a cutting blade 30 relative to the housing 22.

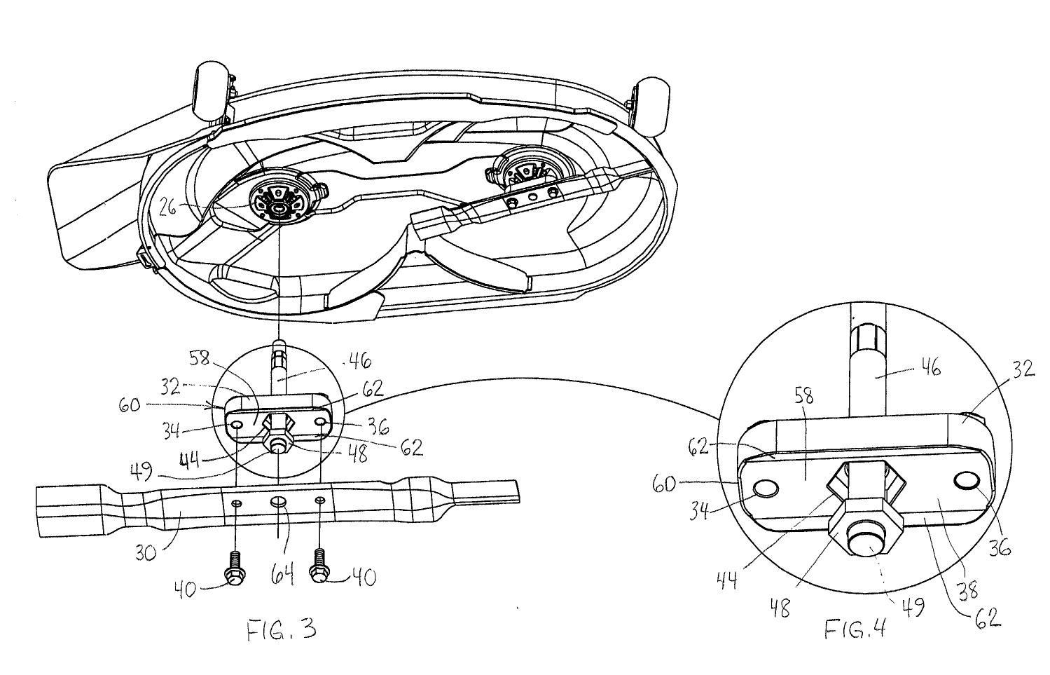

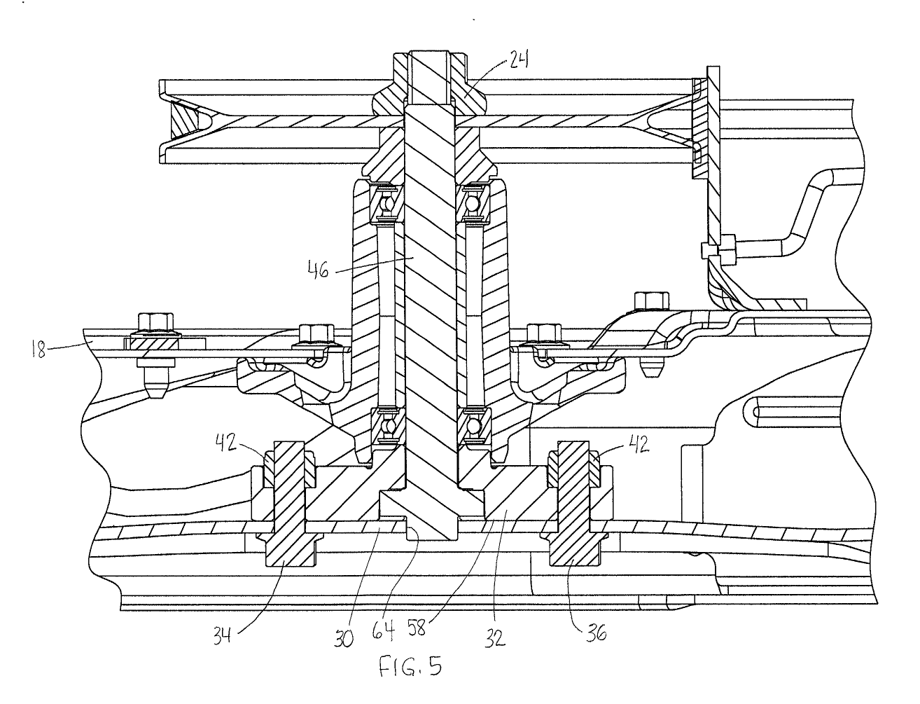

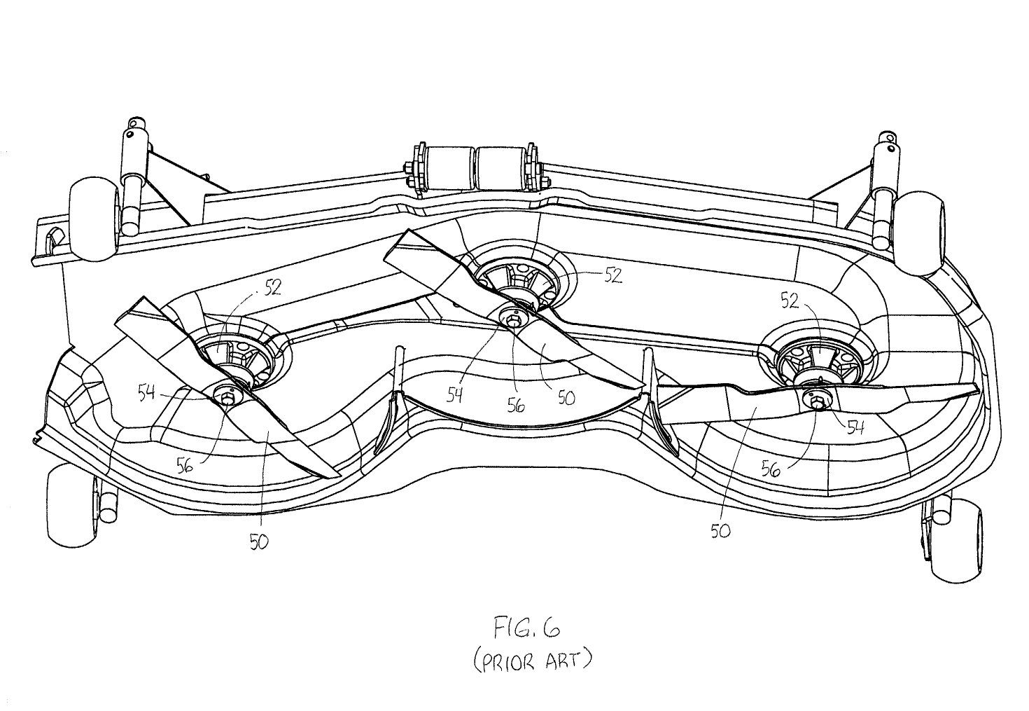

With reference to FIGS. 3 and 4, the assembly 28 for mounting the blade 30 to the spindle housing 22 and the manner in which the blade 30 fastens to the assembly 28 is shown. The assembly 28 consists of a base member or adapter 32 having first and second apertures 34, 36 on its bottom surface 38 thereof for receiving coupling members or bolts 40 which are secured through use of nuts 42 on a top surface thereof as shown in FIG. 5. Intermediate the apertures 34, 36 is a third aperture 44 which receives a cylindrical member or spindle 46 used to hold the blade 30 and the adapter 32 relative to the spindle housing 22. As shown more closely in FIG. 4, the third aperture 44 is provided, preferably, with a hexagonal cross-section which receives a similarly constructed fastening head or extension 48 included on the end of the spindle 46. Although the preferred cross-section of the extension 48 is hexagonal, it is contemplated that any cross section having substantially non-circular mating portions could be used. Adjacent the extension 48 is a round extrusion 49, provided as a portion of the spindle 46, which is inserted through an aperture 64 and assists in centering the blade relative to the assembly 28.

As shown in FIG. 5, the assembly 28 mounts with the blade 30 and the housing 22 in a relatively simple manner whereby each of the blade 30, adapter 32 and spindle 46 are shown therein. With reference to both FIGS. 3 and 5, it can be seen that the blade 30 is fastened against the adapter 32 by the bolts 40 and that the spindle bolt 46 is passed through the adapter 32. As the bolt 46 passes through the adapter 32, the extension 48 seats within the third aperture 44 whereby the spindle 46 is then inserted into the spindle housing 22. At its end opposite the adapter 32, the top of the spindle 46 is secured with the housing 22 by the nut 24. Construction in this manner permits power to be transmitted to the adapter 32 and blade 30 and eliminates disadvantages associated with the friction joint as is seen in FIG. 6. Advantageously, the assembly 28, through use of the adapter 32, avoids difficulties associated with the friction joint. The adapter 32 exerts and distributes shear forces, instead of rotational forces, on the bolts 40 since they are offset from or not inline with the spindle bolt 46 and its axis of rotation. Accordingly, the likelihood of the unintended tightening of the bolts 40 or the adapter 32 to the blade 30 is decreased.

Further, as seen in FIGS. 3 and 4, the adapter includes a large flat surface area 58 on its bottom 60. This flat area 58 includes flanged or downwardly sloped portions 62. Both the flattened area 58 and the sloped portions 62 serve to embrace or interface with mating portions of the blade 30 as can be seen throughout the exploded and unexploded portions of FIG. 3. With this configuration, the blade 30 will have a flattened area of substantially equal size to that of the area 58 to permit it to be engaged against the flattened area 58 and be secured on either side thereof with the bolts 40. As a result of this mounting and contact between the area 58 and the surface of the blade 30 as well as the uniform cross-sectional configuration along length of the blade 30 including the area between where the bolts 40 connect the blade 30 to the adapter 32, the blade 30 and its ends are enabled to resist being moved vertically relative to the housing 26, especially in instances in which objects impact the blade 30. Additionally, the blade 30 is held stable against the adapter 32 during operation so as to further ensure that the level of cut, and even nature thereof, is substantially maintained. Such mounting with the adapter 32 also permits blades of varying thickness to be held stable when operating.

In FIG. 6, the conventional mounting of a cutting blade to a spindle housing can be seen. With that mounting, the blade 50 is held against the spindle housing 52 with a washer 54 and bolt 56 which extends into the housing 52 and is directly inline with the spindle shaft contained within the housing 52. With this mounting method, tightening of the bolt 56 and washer 54 against a first surface of the blade occurs as the blade spins against the housing 52 on an opposite surface thereof. This is especially true in instances in which objects impact the blade and cause the distance between the bolt 56, washer 54, blade 50 and housing 52 to deviate from their original distance when initially adjusted. As described previously, other instances of tightening due to objects impacting the blade when it is spinning can occur when use of the friction joint shown is undertaken.

With respect to the operational aspects of the blade 50, mounting it to the housing 52 with a single bolt 60 across a flattened area often causes disadvantages other than those of tightening. For example, due to the blade not having flanged portions, as discussed with respect to the instant invention, it is less stiff whereas it includes a decreased ability to resist forces which are applied to it. This results since the sides of the blade 50 at their mounting location to the housing 52 have no material, or surface against which such material may be in contact, to otherwise absorb the applied force. Consequently, in the instance in which objects impact the blade, the blade 50 may not be as stiff as it could be causing the ends of the blade to sometimes move vertically with respect to the housing 52. Such a condition often causes undesired instances in which the eveness of the level of cut is disrupted.

Moreover, there exists a tendency, which the instant invention addresses through its mounting structure, for the blade 50 to stray from an even cutting plane so as to deliver a jagged or uneven level of cut. This tendency results, in part, from the small flattened cross-sectional area existing in proximity to the bolt 56 whereby the area has minimal structure to assist in minimizing instances of fluttering which may be described as the movement of the lateral ends or tips of the blade above and below the cutting plane as the blade is operated.

Accordingly, there is provided an assembly for mounting the blade relative to the spindle housing whereby the components of that assembly are constructed and situated to adapt to the blade in a manner that reduces the likelihood of their tightening.

Having described the preferred embodiment, it will become apparent that various modifications can be made without departing from the scope of the invention as defined in the accompanying claims.

we claim:

1. A mounting apparatus for attaching a blade to a generally cutting implement, the apparatus comprising:
a) an elongated base member positioned between the blade having a plurality of vertical apertures along its longitudinal dimension, a pair of the apertures sized to receive coupling members therein for coupling the blade to the base member; and
b) another one of the apertures having a defined surface shape, a cylindrical member passed through the one aperture, the cylindrical member having a portion which is receivably seatable within the one aperture and prevents relative movement between the cylindrical member and the cutting implement.

2. The apparatus as recited in claim 1 wherein:
the portion of the cylindrical member is a hexagonal extension, the extension being matingly engaged with the inner surface of the one aperture so as to distribute force which is to be applied to the cylindrical member to the base member in order to rotate the blade.

3. The apparatus as recited in claim 2 wherein:
the second end of the cylindrical member is securable to the implement by a nut so as to hold the cylindrical member, the base member and the blade to be grasped thereagainst relative to the cutting implement.

4. A blade mounting device for a cutting implement, the device comprising:
a) an adapter having a first aperture therein;
b) a cylindrical member including a longitudinally extending axis and which is inserted through and held within the aperture;
c) second and third apertures provided on opposite sides of the first aperture, respectively, for receiving coupling members on either side of the longitudinal axis to hold the blade against the adapter.

5. The device as recited in claim 4 wherein:
the first aperture has an inner surface which is hexagonal in shape and which receives an extension provided on an end of the cylindrical member whereby contact between the nut and the inner surface permits the transfer of force throughout the adapter so as to permit the blade connected therewith to be turned.

6. The apparatus as recited in claim 5 wherein:
the second end of the cylindrical member is securable to the implement by a nut so as to hold the cylindrical member, the base member and the blade to be grasped thereagainst relative to the cutting implement.

7. A mounting apparatus for attaching a tool to a rotatable shaft, the apparatus comprising:
a) an elongated coupling member having a center opening with at least one additional opening placed on each side of the center opening;
b) a seat provided in the coupling member adjacent the center opening;
c) a fastening member receivable through the center opening and adaptable to be secured to the shaft;
d) means receivable in the additional opening for securing the tool to the coupling member; and
e) a surface provided on the fastening member that is engageable with the seat to prevent relative movement between the fastening member and the coupling member.
